(19) United States
(12) Patent Application Publication
(10) Pub. No.: US 2010/0195240 A1
(43) Pub. Date: Aug. 5, 2010

(54) THERMALLY ASSISTED MAGNETIC RECORDING DISK DRIVE

(75) Inventors: Takayuki Nakakawaji, Kitaibaraki (JP); Mina Amo, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/696,635

(22) Filed: Jan. 29, 2010

(30) Foreign Application Priority Data
Jan. 30, 2009 (JP) 2009-018934

(51) Int. Cl. G11B 5/02

(52) U.S. Cl. 360/59; G9B/5.026

(57) ABSTRACT

A thermally assisted magnetic recording disk drive, comprises: a magnetic recording medium, on a surface of non-magnetic substrate of which are formed an under layer, a vertical magnetic recording layer, a protective layer and a lubricant layer, sequentially; a recording/reproducing head having a magnetic pole, which is configured to apply a magnetic field onto the magnetic recording medium, and a heating means, which is configured to heat an area being applied with a magnetic field by means of a near-field light; a mechanism, which is configured to rotate the magnetic recording medium; a mechanism, which is configured to position the recording/reproducing head; and a circuit, which is configured to process a recording/reproducing signal, and further comprising, a plate-like structure, which supplies a lubricant onto a surface of the magnetic recording medium and thereby having a function of cooling the surface of the magnetic recording medium.

### BACKGROUND OF THE INVENTION

The present invention relates to an information magnetic recording apparatus having a high recording density, and in particular, it relates to a thermally assisted magnetic recording disk drive having a magnetic recording medium and a means for heating the magnetic recording medium with using a near-field light.

With a magnetic disk apparatus, accompanying with high performances of a computer, advancements are made, quickly, for achieving large mass-storage capacity thereof, as well as, small-sizing and light-weighting thereof, and a recording density on the surface of the magnetic disk increases at a rate, being equal to or greater 60% per year. In recent years, due to merger of an optical technology and a magnetic recording technology, development has been made on a thermally assisted magnetic recording disk drive for achieving the recording density of tera-bits class. In thermally-assisted magnetic recording, a magnetic disk is heated by a laser beam or the like, while generating a magnetic field to be applied, and is applied with the magnetic field from an outside by means of a magnetic head under condition of lowering the magnetic coercive force thereof, and thereby recoding information in a recording region thereof. For this reason, it is also easy to record on a medium having high magnetic coercive force, on which recording is difficult by the conventional magnetic head because of shortage of intensity of the recording magnetic field. As a manner for heating the magnetic disk with using a light is already proposed a method of suing a near-field light (Optics Japan 2002 Extended Abstracts, 3pA6 (2002), and Japanese Patent Laying-Open No. 2003-45004 (2003), etc.)

On the other hand, for achieving the high recording density of the magnetic disk, narrowing is also advanced on a magnetic space between the magnetic disk and the magnetic head, and therefore a flying height or deviation of the magnetic head is also lowered down. At present, the flying height of the magnetic head enters into an area of ultra-low flying, such as, 10 nm or less than that, and therefore a film of lubricant can be easily lost, due to heat decomposition or pyrolysis or decomposition of lubricant, or scratching through contact sliding between the magnetic head and the magnetic disk. If the lubrication film is lost or reduced, then not only lowering reliability of sliding between the head/disk, but also increasing the surface energy of the magnetic disk, therefore there are generated obstructions, such as, lowering in the flying stability and the contamination-proof characteristic of the head. For this reason, in order to maintain the sliding reliability between head/disk, it is necessary to keep the film thickness of the lubricant. Also, in the thermally-assisted magnetic recording, since the surface of the magnetic disk is heated locally, being equal or higher than 200° C., in addition to ultra-low-height flying of the head accompanying with demand of high-density of recording, the decomposition and/or evaporation of lubricant is/are accelerated. In the following Non-Patent Document 2 is disclosed a phenomenon of reducing the film thickness at the portion where the lubricant is heated by the laser beam. This is because the decomposition of the lubricant molecules is accelerated, due to the frictional heat when the magnetic head contacts with or slides on the magnetic disk, and also the heating by the laser beam, in addition to a catalytic action by alumina (aluminum oxide) of the head material.

For such technical problem is disclosed a method for maintaining the stable sliding reliability, with supplying the lubricant on the surface of the magnetic disk, to keep the film thickness of lubricant to be constant, and thereby maintaining the stable sliding reliability, in the following Patent Documents 2, 3 and 4. Also, in the thermally-assisted magnetic recording, it is necessary to radiate the heat when heating the magnetic disk with high efficiency, and thereby to control an increase of temperature. In the following Patent Documents 5, 6 and 7 are disclosed means for avoiding the problems due to the increase of temperature.

### Prior Arts

[Patent Documents]

[Patent Document 1] Japanese Patent Laying-Open No. 2003-45004 (2003);

[Patent Document 2] Japanese Patent Laying-Open No. 2002-83484 (2002);

[Patent Document 3] Japanese Patent Laying-Open No. 2003-123232 (2003);

[Patent Document 4] Japanese Patent Laying-Open No. 2002-130789 (2002);

[Patent Document 5] Japanese Patent Laying-Open No. 2002-050026 (2002);

[Patent Document 6] Japanese Patent Laying-Open No. 2001-283403 (2001); and

[Patent Document 7] Japanese Patent Laying-Open No. 2005-317178 (2005).

[Non-Patent Documents]

[Non-Patent Document 1] Optics Japan 2002 Extended Abstracts, 3pA6 (2002); and

[Non-Patent Document 2] International Tribology Conference, Yiao. T. Hsia, June 2 (2005).

### BRIEF SUMMARY OF THE INVENTION

As was mentioned above, in the thermally-assisted magnetic recording, the lubrication film can be lost or reduced, easily, due to the local heating on the magnetic disk surface. For this reason, as well as, mending or repairing the lubrication film reduced, it is also necessary to prevent an increase of temperature on the magnetic disk surface, and to reduce the acceleration of decomposition due to the alumina, i.e., the head material. The thermally assisted magnetic recording disk drive or the recording/reproducing apparatus described in the Patent Documents 5, 6 and 7, although having a means for preventing from an obstacle due to heating and a cooling mechanism for preventing from the increase of temperature, but it is difficult to expect prevention of the decomposition of the lubricant, due to active cooling upon the magnetic disk surface. And, none of those inventions has a function of repairing the lubrication film with supply of the lubricant.

With the Patent Documents 2, 3 and 4, devising a means for supplying the lubricant onto the magnetic disk surface, it is possible to expect an effect of repairing the lubrication film, which is lost or reduced due to the local heating and contacting/sliding between the magnetic head in the thermally-assisted magnetic recording. However, none of those inventions has a function of cooling the magnetic disk surface, and therefore it is impossible to expect the effect of reducing the decomposition of the lubricant. Within the disclosures of those Patent Documents 2, 3 and 4, continuing the decomposition of the lubricant intermittently, it is possible to lessen the loss or reduction of the lubrication film by increasing an amount of the lubricant to be supplied, however if supplying the lubricant, excessively, there is a possibility that the lubricant adheres upon the flying surface of the magnetic head, and thereby bringing about an obstacle of flying thereof.

In the thermally-assisted magnetic recording, and within the heating portion, the decomposition or evaporation of the lubricant is unavoidable; but for the purpose of stopping or staying the decomposition of lubricant at the minimum, it is necessary to cool down the heat caused due to the heating within a time-period, as short as possible; thereby avoiding the heat from accumulation thereof. This is important, not limiting to an aspect of the reliability of sliding between the magnetic head and the magnetic disk, but also of the flying stability of the head and/or the life-time thereof. There is also necessity of repairing the lubrication film, quickly, from the reduction due to the heating thereof.

The present invention, for dissolving the drawbacks mentioned above, has an object to provide a means, having a function of supplying a lubricant onto the magnetic disk surface and also a function of effectively cooling down heat on the magnetic disk surface, which is brought about due to heating in heat-assist, collectively. Thus, according to the present invention, a plate is provided so as to flush an air stream, compulsively, which is generated due to rotation of the magnetic disk, on the magnetic disk surface in vicinity of the magnetic head, which is heated by a heating means thereof, and thereby accelerating the cooling effect, and also supplying a lubricant from the plate. With this, the reduction or loss of the lubrication film can be lessened, greatly, even if the magnetic head conducts recording/reproducing when flying at the ultra-low height while being heated up to 200° C. or higher than that in the thermally-assisted recording, and thereby enables to provide a thermally assisted magnetic recording disk drive having high reliability thereof.

Thus, the present invention is provided for dissolving the loss or reduction of the lubrication film, which brings about the problem(s) in the thermally-assisted magnetic recording, as well as, the increase of temperature of the magnetic disk and the magnetic head, etc. More details of the means, being provided according to the present invention are as below.

First of all, according to the present invention, there is provided a thermally assisted magnetic recording disk drive, comprising: a magnetic recording medium, on a surface of non-magnetic substrate of which are formed an under layer, a vertical magnetic recording layer, a protective layer and a lubricant layer, sequentially; a recording/reproducing head having a magnetic pole, which is configured to apply a magnetic field onto said magnetic recording medium, and a heating means, which is configured to heat an area being applied with a magnetic field by means of a near-field light; a mechanism, which is configured to rotate said magnetic recording medium; a mechanism, which is configured to position said recording/reproducing head; and a circuit, which is configured to process a recording/reproducing signal, and further comprising, a plate-like structure, which supplies a lubricant onto a surface of said magnetic recording medium and thereby having a function of cooling the surface of said magnetic recording medium. As the plate-like structure may be listed up a solid body, for example, a metal plate, a ceramic member, or a resin member, etc., but a porous body is preferable, such as, a wick member, etc., which can absorb the lubricant therein. With applying the porous body, molecules of the lubricant can be supplied on the magnetic disk surface with an aid of airflow, and thereby obtaining a sliding stability.

Second, according to the present invention, in the thermally assisted magnetic recording disk drive, as described in the above, wherein a plane portion of said plate-like structure has a plate having a tapered cross-section having an inclination of 3 degree or less than that with respect to an opposite surface of said magnetic recording medium, and has a fan-shaped plane, which continuously increases a surface/volume ratio thereof directing to a side of an inner periphery of said magnetic recording medium. Details thereof will be illustrated in the embodiments, but the plate-like structure has the taper-like cross-section. With this, the airflow generated due to rotation of the magnetic disk is compulsively driven to flow on the surface of the magnetic disk, and thereby enabling to cooling down the disk surface effectively. Also, the plane portion of the plate-like structure is in the fan-like shape, increasing an area thereof direction to an inner periphery side of the magnetic disk. With this, it is possible to keep supply amounts of the lubricant to be constant, on both sides, an inner periphery side where a peripheral velocity is slow, and an outer periphery side where the periphery where a peripheral velocity is fast.

Third, according to the present invention, in the thermally assisted magnetic recording disk drive, as described in the above, wherein said plate-like structure opposes to both surfaces of said magnetic recording medium, without contacting therewith, and is positioned in vicinity of said recording/reproducing head. With disposing the plate-like structure in the vicinity of the recording/reproducing head, difference of temperature between a heating portion and a cooling portion comes to be large, and thereby enabling an effective heat radiation.

Fourth, according to the present invention, in the thermally assisted magnetic recording disk drive, as described in the above, wherein on a surface of in an inside of said plate-like structure is applied or impregnated a fluorinated compound, which has a number average molecular weight of 2,000 or less than that and a vapor pressure of 10⁻⁵ Pa under a circumference of 20° C. Thus, according to the present invention, the lubricant is supplied on the magnetic disc surface with utilizing the airflow, which is generated by the rotation of the magnetic disk. With taking an affinity between the lubricant film on the magnetic disk surface into the consideration thereof, it is preferable to select a fluorinated compound; as the lubricant to be supplied, too. Also, in case where a molecular weight of the lubricant to be supplied is too large, or a vapor pressure thereof is too low, it is impossible to supply the lubricant from the plate-like structure. As a result of experiments, it can be supplied with stability, if being fluorinated compounds, having a number average molecular weight of 2,000 or less than that and a vapor pressure of 10⁻⁵ Pa under a circumference of 20° C. As the fluorinated compounds, there can be listed up the lubricants having the following structural formulas.

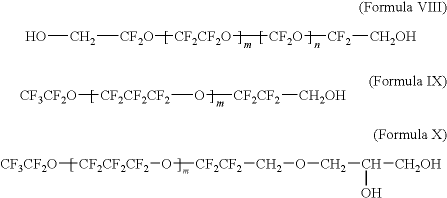

Fifth, according to the present invention, according to the present invention, in the thermally assisted magnetic recording disk drive, as described in the above, wherein the lubricant of said magnetic recording medium is constructed with at least of one (1) kind of perfluoropolyethers, which can be expressed by the following formulas; [Formula XI], [Formula XII], [Formula XIII], [Formula XIV], [Formula XV], [Formula XVI] and [Formula XVII]:

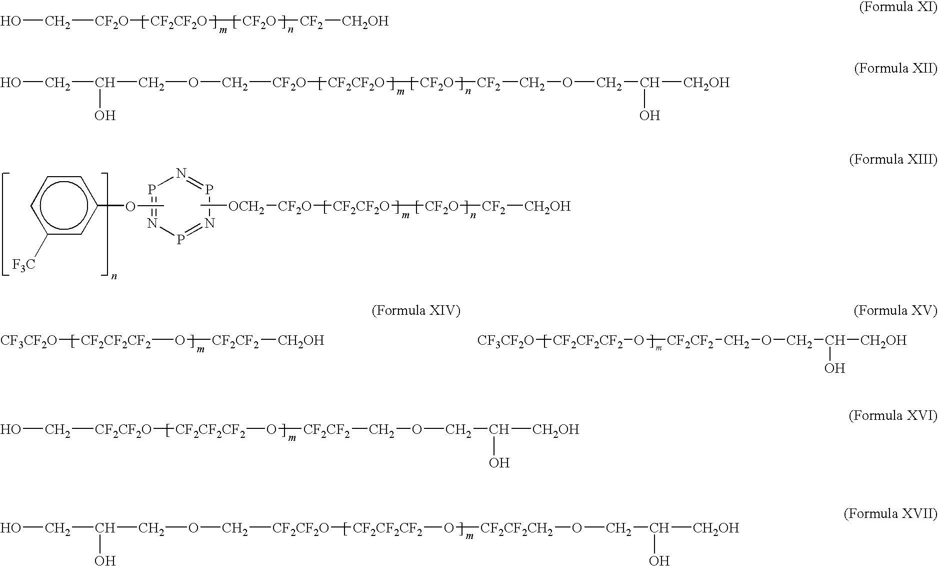

Sixth, the thermally assisted magnetic recording disk drive, as described in the above, wherein thickness of the lubrication film after rinsing said magnetic recording medium by a fluorine solvent is equal to or greater than 40% of that before rinsing thereof. The lubrication film on the magnetic disk surface is constructed with a layer of a lubricant, which is strongly absorbed on the disk surface (i.e., a fixed layer), and a layer (i.e., a free layer), absorption of which is weak or the lubricant is not absorbed therein. If the ratio of the fixed layer is lowered, then the lubricant can easily fly or adhere on the head, therefore the reduction or less of the lubrication film comes to large. For the propose of lowering the reduction or less of the lubrication film, the ratio of the fixed layer is determined, at least, to be equal to or greater than 40%, then it is possible to lower the reduction or less of the lubrication film, and thereby obtaining the stable sliding reliability when conducting the thermally assisted magnetic recording.

Seventh, the thermally assisted magnetic recording disk drive, as described in the above, wherein said magnetic recording medium is treated with a process of irradiating ultraviolet rays thereon, which have a wavelength of 300 nm or less than that. With irradiation of the ultraviolet rays, having the wavelength of 300 nm or less than that, upon the lubrication film, it is possible to increase the ratio of the layer, which is strongly absorbed on the disk surface (i.e., a fixed layer). It is also possible to change the ratio through adjusting the time (an accumulated amount of lights) of irradiation of the ultraviolet rays, and with optimization of the ratio of the fixed layer, it is possible to maintain the stable sliding reliability when conducting the thermally assisted magnetic recording.

According to the present invention, with provision of the plate-like structure applying or impregnating the lubricant thereon/in in the vicinity of the head, it is possible to supply the lubricant onto the magnetic disk surface with an aid of the airflow generated by the rotation of the magnetic disk. Also, with determining the molecular weight and/or the vapor pressure of the lubricant to be supplied, or with forming the plate-like structure into the fan-like shape, it is possible to supply the lubricant, more stably. Further, on the plate-like structure, since having the taper-like cross-section, the airflow generated by the rotation of the magnetic disk is guided to flow on the surface side of the magnetic disk, compulsively, and the temperature difference comes to be large between the heating portion and the cooling portion; this enables to cool down the disk surface, effectively. With this, as well as, lowering the decomposition of the lubricant due to contact/sliding between the magnetic head, it is also possible to achieve the stable recording/reproducing. Also, forming the lubrication film on the magnetic disk surface, with increasing the ratio of the layer, which strongly absorbs the lubricant therein (the fixed layer), brings about an effect of lowering/reducing of the lubricant film. With applying the present invention into the thermally assisted magnetic recording disk drive, it is possible to obtain stable recording/reproducing.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for showing the structures of a thermally assisted magnetic recording disk drive, according to an embodiment of the present invention;

FIG. 2 is an enlarged perspective view of a plate-like structure, which is provided in the thermally assisted magnetic recording disk drive shown in FIG. 1;

FIGS. 3A and 3B are a top view and a side view for showing a testing apparatus, which is used for verifying effects of the present invention, in particular, between embodiments 1, 2, 3 and 5 and comparative examples 1, 2, 3, 4 and 5;

FIG. 4 is a graph for showing the changes of thickness of a lubrication film, with respect to a time, in particular, between the embodiment 1 and the comparative examples 1 and 2;

FIG. 5 is a graph for showing the changes of thickness of a lubrication film, with respect to a time, in particular, between the embodiment 2 and the comparative example 3;

FIG. 6 is a graph for showing the changes of thickness of a lubrication film, with respect to a time, in particular, between the embodiment 3 and the comparative example 4; and

FIG. 7 is a graph for showing the changes of thickness of a lubrication film, with respect to a time, in particular, between the embodiment 4 and the comparative example 5.

### DETAILED DESCRIPTION OF THE PREFERRED EMBODIMENTS

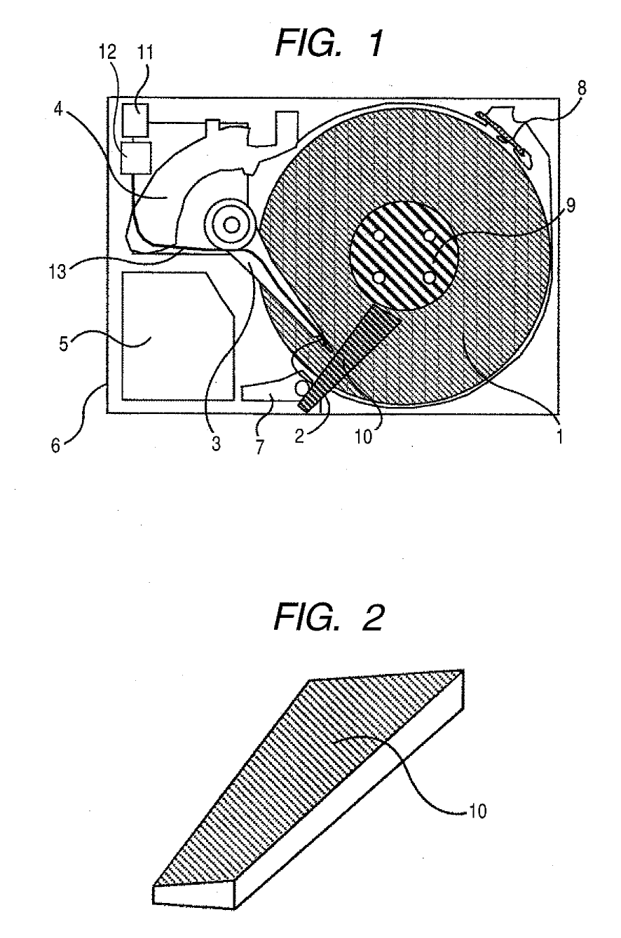

Hereinafter, embodiments according to the present invention will be fully explained by referring to the attached drawings. FIG. 1 is a view for showing the structures of a thermally assisted magnetic recording disk drive according to the present invention. Within the thermally assisted magnetic recording disk drive, there is/are provided or mounted one (1) or a plural number of pieces of magnetic disk(s) 1. The magnetic disk 1 according to the present invention is a magnetic disk, for use of vertical magnetic recording, which comprises a soft magnetic under layer and a vertical magnetic recording layer. A magnetic head 2 fixed at a tip of a carriage 3 can access to an arbitrary track by means of a voice-coil motor 4, thereby to conduct recording/reproducing of information on the magnetic disk 1 (i.e., a magnetic recording medium). A plate-like structure 10, according to the present invention, is disposed in the vicinity of the magnetic head 2, opposing to the surface of the magnetic disk 1. FIG. 2 is an enlarged view of the structure 10. The structure 10 is made of sintering alumina (aluminum oxide), and has a fan-shaped flat surface and a tapered cross-section thereof.

A laser beam irradiating from a semiconductor laser 11, i.e., a light source, passing through a light exchanger 12, is guided into the magnetic head 2 through an optical fiber 13, and generates a near-field light. With heating of the magnetic disk 1 by the hear field light generated, there can be obtained an effect of the heat assist.

### Embodiments

Though explanation will be made about the present invention, by referring to embodiments thereof, hereinafter, however the present invention should not be limited to those embodiments.

### Embodiment 1

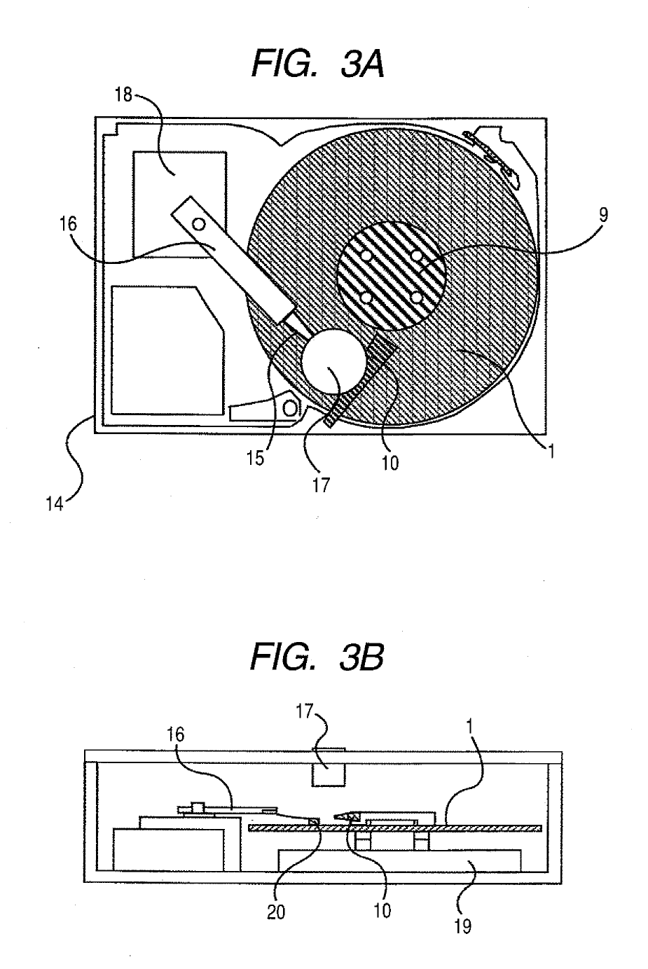

In the present embodiment can be verified a lubricant supply effect from the plate-like structure 10 and also a cooling effect on the magnetic disk surface. In FIGS. 3A and 3B is shown a testing apparatus, which is used in the present embodiment. The present testing apparatus 14 is built up upon basis of an actual magnetic disk apparatus, and enables estimation under the actual machine. In the present embodiment, for the purpose of accelerating contact/sliding between the magnetic head and the magnetic disk, there is applied a spherical slider 20 made of alumina, i.e., the material of a magnetic head slider. The spherical slider 20 has a curvature of R 5 mm, for example. The spherical slider 20 is attached onto an arm 16 through a gimbal 15, and contacts on the magnetic disk surface at a load 9.8 mN. A spindle motor 19 and a voice coil motor 18 are improved to be changeable, for example, of the disk rotation speed and/or frequencies of seek. As a means for heating the magnetic disk surface is applied a small-sized halogen spot heater 17, thereby heating the magnetic disk surface, continuously, in vicinity of the spherical slider (on the side of an end of flow-out).

Upon a glass substrate having diameter of 65 mm (2.5 inches) are formed a soft magnetic layer, a non-magnetic intermittent or middle layer, and a CoCr alloy magnetic recording layer and a carbon protective layer, sequentially, through the spattering method, and upon the carbon protective layer mentioned above is formed a lubrication film, having the following structural formula (the number average molecular weight 2380), with film thickness of 1.2 nm; thereby the magnetic disk 1 obtained is installed within the testing apparatus 14. The thickness of the lubrication film is measured by a FT-IR (Fourier transform Infrared Spectrometer).

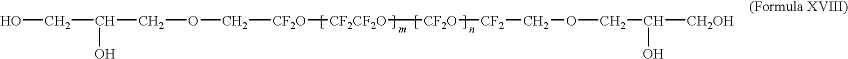

Further, after rinsing the formed lubrication film by a fluorine solvent (e.g., HFE 7100, made by Sumitomo 3M Co.), as a result of measuring the film thickness, it is 0.57 nm. A ratio of the lubricant layer (i.e., a fixed layer) strongly absorbed on the magnetic disk surface is 47.5%. Next, a solution is produced by diluting a lubricant, having the following structural formula (the number average molecular weight 2130), into the fluorine solvent (e.g., HFE 7100, made by Sumitomo 3M Co.) at 0.8 wt %, and this solution is applied on the plate-like structure 10 through the dip method.

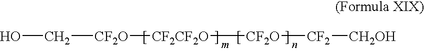

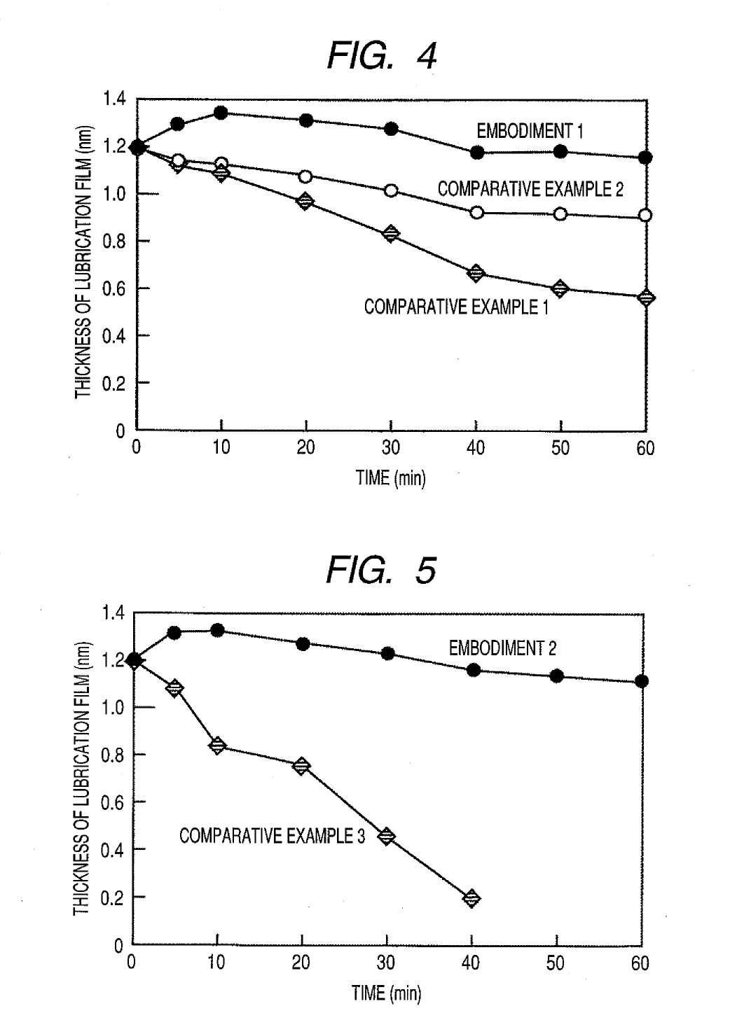

The plate-like structure 10, on which the lubricant mentioned above is applied, is attached on the magnetic disk 1, as is shown in FIGS. 3A and 3B. The magnetic disk 1 is heated on a tack portion thereof, having a radius of 22 mm, at 250° C. through irradiating lights thereon by the halogen spot heater 17, and is rotated at 4,200 rpm. Also, while rotating the magnetic disk 1, the spherical slider 20 is driven to sweep the surface having a radius from 16 mm to 28 mm. An irradiating portion of the halogen spot heater 17 is φ3 mm. FIG. 4 shows changes of thickness of the lubrication film of the track portion (radius 22 mm), which is heated by the halogen spot heater 17 with respect to the time. In a comparative example 1, with which the test is conducted under the same condition to that of the present embodiment, but without provision of the plate-like structure 10, the thickness of the lubrication film decreases down to 0.6 nm after passing 60 minutes from starting the measurement thereof. Also, in a comparative example 2, with which the test is conducted under the same condition to that of the present embodiment, with providing the plate-like structure 10, but applying no lubricant mentioned above thereon, the thickness of the lubrication film decreases down, but it is nearly constant after passing 40 minutes. As the reason why the reduction or loss of the thickness of the lubrication film in the comparative example 2 is smaller than that of the comparative example 1, it can be expected due to the fact that the evaporation or decomposition of the lubricant is lessened because of the cooling effect on the magnetic disk surface by means of the plate-like structure 10. On the other hand, comparing to the results of those comparative examples, according to the present embodiment, because of supply of the lubricant from the plate-like structure 10 and the cooling effect of the magnetic disk surface, there can be obtained a stable sliding durability without reducing or loosing the thickness of the lubrication film.

### Embodiment 2

A lubrication film, having the following structural formula (the number average molecular weight 2130) is formed on the protective film surface of the magnetic disk 1 with the film thickness of 1.2 nm, with the same method to that of the embodiment 1. Next, irradiation of ultraviolet rays of 172 nm is conducted upon the magnetic disk 1, on which the lubrication film mentioned above is formed thereon, with using an excimer UV lamp (an Xe lamp). An accumulated amount of lights is 140 mJ/cm². The magnetic disk 1, being irradiated by the ultraviolet rays, is installed in the testing apparatus 14.

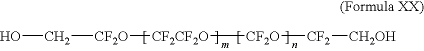

As a result of calculating the ratio of the lubricant layer (i.e., the fixed layer) absorbing onto the surface of the magnetic disk 1, which is used in the present embodiment, in the same manner to that of the embodiment 1, it is 48%. The lubricant, being same to that applied on the magnetic disk 1, is applied on the plate-like structure 10, and it is attached on the magnetic disk 1 mentioned above, as is shown in FIGS. 3A and 3B. While driving it to sweep under the same condition to that of the embodiment 1, measurement is conducted on changes of the thickness of the lubrication film. FIG. 5 shows the changes of the thickness of the lubrication film on the track portion (radius 22 mm), which is heated by the halogen spot heater 17 with respect to the time. In a comparative example 3, with which the test is conducted under the same condition to that of the present embodiment, but without provision of the plate-like structure 10, the thickness of the lubrication film decreases down to 0.2 nm after passing 40 minutes from starting the measurement thereof, and a sliding trace is generated on the surface of the magnetic disk 1. On the contrary to this, according to the present embodiment, approximately, no reduction or loss is generated, and there can be obtained a stable sliding durability.

### Embodiment 3

A lubrication film, having the following structural formula (the number average molecular weight 2280) is formed on the protective film surface of the magnetic disk 1 with the film thickness of 1.3 nm, with the same method to that of the embodiment 1. In the similar manner to that of the embodiment 2, irradiation of ultraviolet rays of 172 nm is conducted upon the magnetic disk 1, on which the lubrication film mentioned above is formed thereon, with using the excimer UV lamp (an Xe lamp). An accumulated amount of lights is 140 mJ/cm². The magnetic disk 1, being irradiated by the ultraviolet rays, is installed in the testing apparatus 14.

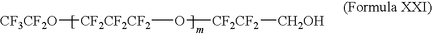

As a result of calculating the ratio of the lubricant layer (i.e., the fixed layer) absorbing onto the surface of the magnetic disk 1, which is used in the present embodiment, in the same manner to that of the embodiments 1 and 2, it is 51%. In the similar manner to those of the embodiments 1 and 2, the lubricant, which will be mentioned below (the number average molecular weight 2130) is applied on the plate-like structure 10, and it is attached on the magnetic disk 1 mentioned above, as is shown in FIGS. 3A and 3B.

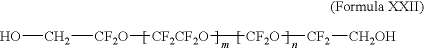

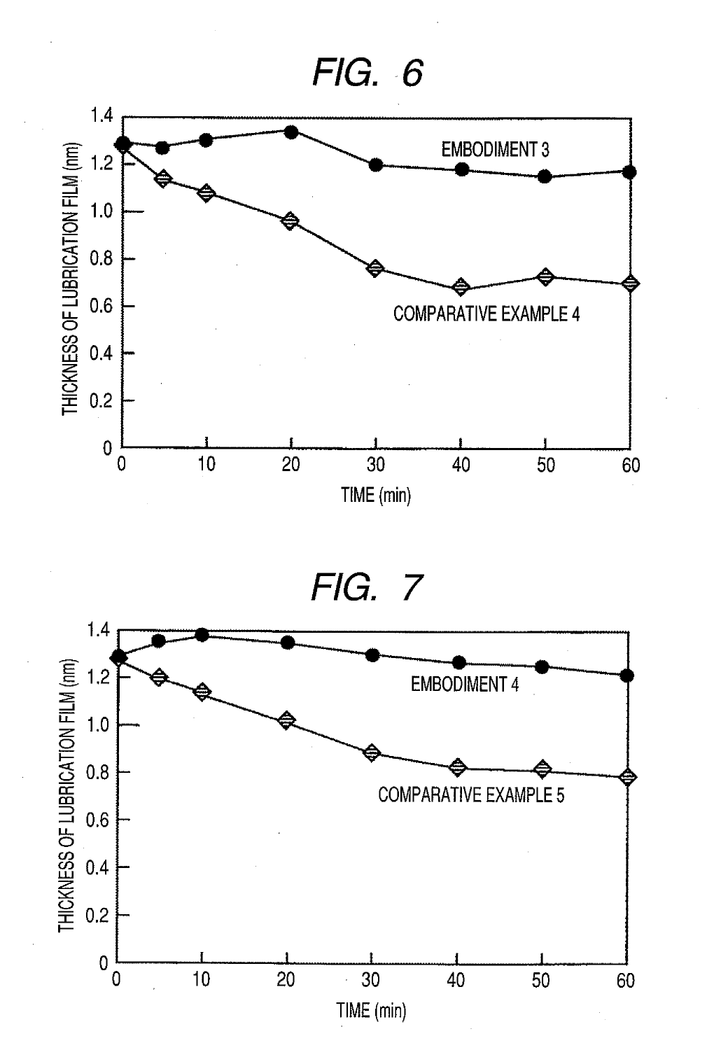

While driving it to sweep under the same condition to that of the embodiments 1 and 2, measurement is conducted on changes of the thickness of the lubrication film. FIG. 6 shows the changes of the thickness of the lubrication film on the track portion (radius 22 mm), which is heated by the halogen spot heater 17 with respect to the time. In a comparative example 4, with which the test is conducted under the same condition to that of the present embodiment, but without provision of the plate-like structure 10, the thickness of the lubrication film decreases down to 0.71 nm after passing 60 minutes from starting the measurement thereof. On the contrary to this, according to the present embodiment, approximately no reduction or loss is generated, and there can be obtained a stable sliding durability.

### Embodiment 4

A lubrication film, having the following structural formula (the number average molecular weight 2490) is formed on the protective film surface of the magnetic disk 1 with the film thickness of 1.3 nm, with the same method to that of the embodiment 1, and it is installed in the testing apparatus 14.

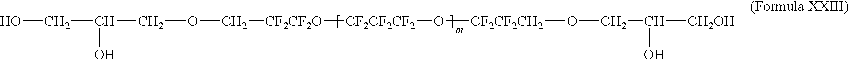

As a result of calculating the ratio of the lubricant layer (i.e., the fixed layer) absorbing onto the surface of the magnetic disk 1, which is used in the present embodiment, in the same manner to that of the embodiment 1, it is 62%. In the similar manner to those of the embodiment 1, the lubricant, which will be mentioned below (the number average molecular weight 2070) is applied on the plate-like structure 10, and it is attached on the magnetic disk 1 mentioned above, as is shown in FIGS. 3A and 3B.

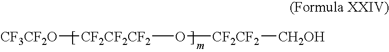

While driving it to sweep under the same condition to that of the embodiments 1 and 2, measurement is conducted on changes of the thickness of the lubrication film. FIG. 7 shows the changes of the thickness of the lubrication film on the trackportion (radius 22 mm), which is heated by the halogen spot heater 17 with respect to the time. In a comparative example 5, with which the test is conducted under the same condition to that of the present embodiment, but without provision of the plate-like structure 10, the thickness of the lubrication film decreases down to 0.78 nm after passing 60 minutes from starting the measurement thereof. On the contrary to this, according to the present embodiment, approximately no reduction or loss is generated, and there can be obtained a stable sliding durability.

### Embodiment 5

In the present embodiment, verification is done upon an effect of the present invention, in particular, within an actual thermally assisted magnetic recording disk drive. A lubrication film, having the following structural formula (the number average molecular weight 2490) is formed on the protective film surface of the magnetic disk 1 with the film thickness of 1.0 nm, with the same method to that of the embodiment 1, and it is installed in the thermally assisted magnetic recording disk drive shown in FIG. 1.

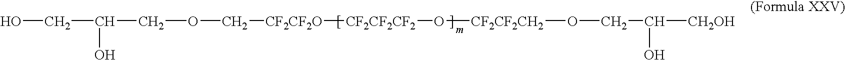

Next, in the similar manner to that of the embodiment 1, a lubrication film, having the following structural formula (the number average molecular weight 2070), is formed on the plate-like structure 10 made of sintering alumina, and it is attached on the magnetic disk 1 mentioned above, as is shown in FIG. 1.

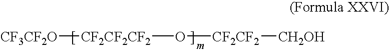

The laser beam irradiating from the semiconductor laser 11, as the light source, is guided into the magnetic head 2 through the optical fiber, thereby to generate the near-field light, i.e., while heating the magnetic disk 1 therewith is conducted recording/reproducing. The heating temperature on the surface of the magnetic disk 1 is about 250° C. As a result of measurement of the thickness of the lubrication film, after conducting the recording/reproducing for 120 hours, continuously, it is 1.05 nm. With applying the present invention therein, it is possible to provide a thermally assisted magnetic recording disk drive, with low noises, and also being superior in the sliding reliability thereof.

### Comparative Example 1

The magnetic disk 1, on which the lubrication film same to that of the embodiment 1 is formed, is installed in the testing apparatus 14 shown in FIGS. 3A and 3B, but without provision of the plate-like structure 10, and test is conducted thereon under the same condition to the embodiment 1. FIG. 4 shows the changes of the thickness of the lubrication film with respect to the time. The thickness of the lubrication film is goes down to 0.6 nm after passing 60 minutes from starting the measurement, but on the contrary thereto, according to the embodiment 1, no reduction or loss of the thickness of the lubrication film is generated, and therefore it is confirmed that the stable sliding reliability can be obtained with application of the present invention.

### Comparative Example 2

The magnetic disk 1, on which the lubrication film same to that of the embodiment 1 is formed, is installed in the testing apparatus 13 shown in FIGS. 3A and 3B, and the plate-like structure 10, but no such lubricant is applied thereon, is provided on the magnetic disk 1. Test is conducted thereon under the same condition to the embodiment 1. FIG. 4 shows changes of the thickness of the lubrication film with respect to the time. Although decreasing down to 0.9 nm until when elapsing 40 minutes from the beginning of measurement, but thereafter the thickness of the lubrication film comes to be constant, approximately. Since the reduction or loss is small in the thickness of the lubrication film, comparing to the embodiment 1, the reduction or loss of the thickness of the lubrication film is lowered due to the cooling effect of the plate-like structure 10, and the sliding reliability is improved.

### Comparative Example 3

The magnetic disk 1, on which the lubrication film same to that of the embodiment 2 is formed, is installed in the testing apparatus 14 shown in FIGS. 3A and 3B, and the test is conducted thereon under the same condition to the embodiment 2, but without provision of the plate-like structure 10. FIG. 5 shows changes of the thickness of the lubrication film with respect to the time. The thickness of the lubrication film decreases down to 0.2 nm after passing 40 minutes from starting the measurement thereof, and the sliding trace is generated on the surface of the magnetic disk 1. On the contrary to this, according to the embodiment 2, no reduction or loss is generated in the thickness of the lubrication film, i.e., it is confirmed that the stable sliding durability can be obtained with application of the present invention.

### Comparative Example 4

The magnetic disk 1, on which the lubrication film same to that of the embodiment 3 is formed, is installed in the testing apparatus 14 shown in FIGS. 3A and 3B, and the test is conducted thereon under the same condition to the embodiment 3, but without provision of the plate-like structure 10. FIG. 6 shows changes of the thickness of the lubrication film with respect to the time. The thickness of the lubrication film decreases down to 0.71 nm after passing 60 minutes from starting the measurement thereof. On the contrary to this, according to the embodiment 3, no reduction or loss is generated in the thickness of the lubrication film, i.e., it is confirmed that the stable sliding durability can be obtained with application of the present invention.

### Comparative Example 5

The magnetic disk 1, on which the lubrication film same to that of the embodiment 4 is formed, is installed in the testing apparatus 14 shown in FIGS. 3A and 3B, and the test is conducted thereon under the same condition to the embodiment 3, but without provision of the plate-like structure 10. FIG. 7 shows changes of the thickness of the lubrication film with respect to the time. The thickness of the lubrication film decreases down to 0.78 nm after passing 60 minutes from starting the measurement thereof. On the contrary to this, according to the embodiment 4, no reduction or loss is generated in the thickness of the lubrication film, i.e., it is confirmed that the stable sliding durability can be obtained with application of the present invention.

### Utility of the Invention

According to the present invention, it is possible to obtain a thermally assisted magnetic recording disk drive superior in the reliability thereof, having a surface recording density of 1 Tb/in² or more. The thermally assisted magnetic recording disk drive obtained according to the present invention is allocable in consumer equipment, such as, a personal computer, a server system, and a DVD recorder, or a car navigation system, etc.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A thermally assisted magnetic recording disk drive, comprising:
a magnetic recording medium, on a surface of non-magnetic substrate of which are formed an under layer, a vertical magnetic recording layer, a protective layer and a lubricant layer, sequentially;
a recording/reproducing head having a magnetic pole, which is configured to apply a magnetic field onto said magnetic recording medium, and a heating means, which is configured to heat an area being applied with a magnetic field by means of a near-field light;
a mechanism, which is configured to rotate said magnetic recording medium;
a mechanism, which is configured to position said recording/reproducing head; and
a circuit, which is configured to process a recording/reproducing signal, and further comprising,
a plate-like structure, which supplies a lubricant onto a surface of said magnetic recording medium and thereby having a function of cooling the surface of said magnetic recording medium.

2. The thermally assisted magnetic recording disk drive, as described in the claim 1, wherein a plane portion of said plate-like structure has a plate having a tapered cross-section having an inclination of 3 degree or less than that with respect to an opposite surface of said magnetic recording medium, and has a fan-shaped plane, which continuously increases a surface/volume ratio thereof directing to a side of an inner periphery of said magnetic recording medium.

3. The thermally assisted magnetic recording disk drive, as described in the claim 1, wherein said plate-like structure opposes to both surfaces of said magnetic recording medium, without contacting therewith, and is positioned in vicinity of said recording/reproducing head.

4. The thermally assisted magnetic recording disk drive, as described in the claim 1, wherein on a surface of in an inside of said plate-like structure is applied or impregnated a fluorinated compound, which has a number average molecular weight of 2,000 or less than that and a vapor pressure of 10⁻⁵ Pa under a circumference of 20° C.

5. The thermally assisted magnetic recording disk drive, as described in the claim 1, wherein the lubrication film of said magnetic recording medium is constructed with at least of one (1) kind of perfluoropolyethers, which can be expressed by the following formulas; [Formula I], [Formula II], [Formula III], [Formula IV], [Formula V], [Formula VI] and [Formula VII]:

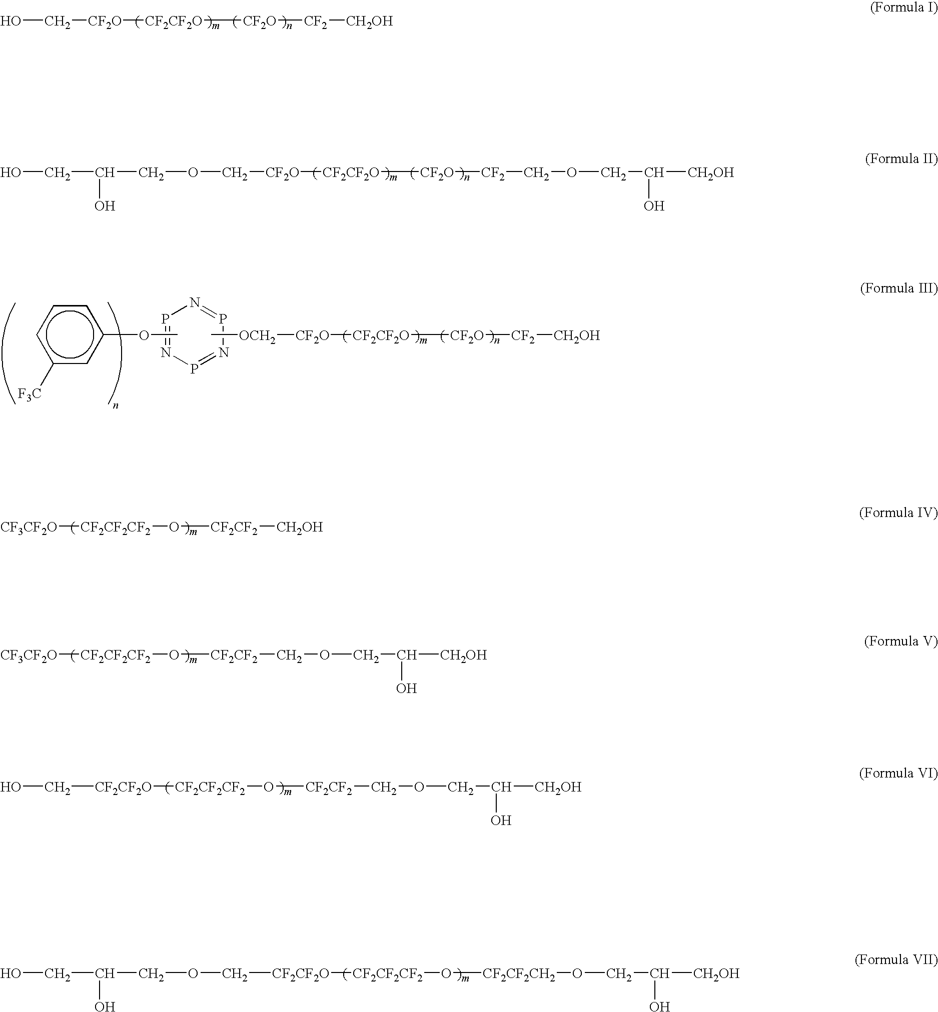

6. The thermally assisted magnetic recording disk drive, as described in the claim 1, wherein thickness of the lubrication film after rinsing said magnetic recording medium by a fluorine solvent is equal to or greater than 40% of that before rinsing thereof.

7. The thermally assisted magnetic recording disk drive, as described in the claim 1, wherein said magnetic recording medium is treated with a process of irradiating ultraviolet rays thereon having a wavelength of 300 nm or less than that.
